(19) United States
(12) Patent Application Publication
(10) Pub. No.: US 2010/0227124 A1
(43) Pub. Date: Sep. 9, 2010

(54) FLOOR MAT AND METHOD OF MAKING THE SAME

(75) Inventor: Nadav Sharir, Raleigh, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Glenoit LLC

(21) Appl. No.: 12/396,887

(22) Filed: Mar. 3, 2009

(51) Int. Cl. B32B 3/26; B32B 7/12; B29C 59/00; C08J 9/04; B32B 5/18

(52) U.S. Cl. 428/159; 428/317.1; 264/293; 264/54; 156/242

(57) ABSTRACT

A floor mat and a method of making the floor mat are provided. The method may include forming a foam polyvinyl chloride body of a floor mat. The body may be embossed to form one or more thicker and thinner regions of the body. Moreover the thicker and thinner regions may be arranged to define panels and folding lines of the body such that the panels are foldable relative to each other. In some embodiments, the body may include a plurality of fold lines between adjacent panels to allow for a large folding radius. Other operations of the method may include embroidering a design onto the body or attaching a fabric layer to a top surface of the body of the floor mat.

### BACKGROUND

The present invention relates to floor mats and methods of making floor mats.

Typically, a floor mat is a pad of material used to cover a portion of a floor. Floor mats have multiple functions. For example, a floor mat may be intended primarily for aesthetic purposes such as providing color or other decorative aspect to a floor or room. As another example, a floor mat may be configured to provide a more utility function such as to protect the floor or provide an area for people to wipe off their shoes. And yet another example, a floor mat may be configured to provide cushioning or support for activities such as exercise. Some floor mats may be intended for multiple functions and uses. Due to the different functions and uses, floor mats may vary in shape and sizes.

Regardless of function, most users or buyers of floor mats are generally sensitive to price. Therefore, it would be beneficial to provide a floor mat and method of making the same that is economical and can support multiple uses.

### BRIEF SUMMARY

One or more embodiments of a floor mat and a method of making a floor mat are disclosed herein that may address one or more of the above issues. For example, according to am embodiment a floor mat is provided that includes a body of a foam polyvinyl chloride material having at least a top surface and a bottom surface and defining a thickness. In this embodiment, the thickness varies to form at least one thinner region of the body and at least one thicker region of the body.

The body may include a plurality of panels formed by a plurality of relative thicker regions of the body and a plurality of fold lines formed by a plurality of relative thinner regions of the body. At least one fold line may extend between each adjacent panel such that that the plurality of panels are foldable relative to each other. The plurality of panels may include a plurality of rows of panels and a plurality of columns of panels. In other embodiments, the mat may include a plurality of fold lines extending between each adjacent row of panels. For example, the plurality of fold lines may include three fold lines extending between each adjacent rows of panels. In such an embodiment, the body may further include a bead of the foam PVC material between each of the three fold lines. The bead may have a thickness substantially equal to the thickness of a panel between each of the three fold lines.

In other embodiments, the body includes a plurality of thinner and thicker regions that form a pattern of bricks extending across the body or form a pattern that includes a plurality of rows and columns of an object. The pattern may further include a central region forming one or more words.

In other embodiments, instead of or in addition to the thicker and thinner regions, the floor mat may further include a fabric layer attached to the top surface of the body by a direct seal between the two, an adhesive, or other fastener means. The fabric layer may further include one or more yarns sewed into the top surface according to a particular pattern.

Other embodiments provide methods of making or manufacturing a floor mat. For example, according to an embodiment, the method includes providing a supply of polyvinyl chloride pellets; melting the polyvinyl chloride pellets to form a liquid solution of polyvinyl chloride; vulcanizing the liquid solution into a sold form in order to produce a body of the floor mat; cutting the body according to a desired overall shape of the floor mat; and embossing the body to form one or more thicker and thinner regions of the body. The method may further include a blowing agent of the polyvinyl chloride pellets such that the body is of a foam polyvinyl chloride material.

The embossing operation may include forming a plurality of panels and fold lines with the one or more thicker and thinner regions of the body such that the panels are foldable relative to one another. For example, the embossing of the body may include forming a plurality of fold lines between at least two adjacent panels.

According to another embodiment, the embossing operation may include forming a pattern of bricks extending across the body with the one or more thicker and thinner regions or forming a pattern that includes a plurality of rows and columns of an object with the one or more thicker and thinner regions. The pattern may further include a central region forming one or more words.

Instead of or in addition to the embossing operation, the method may include embroidering a particular design into the body or attaching a fabric layer to the top surface of the body. The cutting of the body may be performed prior to or after the operation of attaching the fabric layer to the top surface of the body.

### BRIEF DESCRIPTION OF THE SEVERAL VIEWS OF THE DRAWING(S)

Reference will now be made to the accompanying drawings, which are not necessarily drawn to scale, and wherein:

FIG. 1A is a perspective view of a floor mat consistent with an embodiment;

FIG. 1B is a side view of the floor mat of FIG. 1A;

FIG. 2A is a top view of a floor mat consistent with another embodiment;

FIG. 2B is a side view of the floor mat of FIG. 2A;

FIG. 3A is a top view of a floor mat consistent with another embodiment;

FIG. 3B is a side view of the floor mat of FIG. 3A;

FIG. 4 is a top view of a floor mat consistent with another embodiment;

FIG. 5A is a top view of a floor mat consistent with another embodiment in an unfolded configuration;

FIG. 5B is a side view of the floor mat of FIG. 5A in the unfolded configuration;

FIG. 5C is a side view of the floor mat of FIG. 5A in a folded configuration;

FIG. 6A is a top view of a floor mat consistent with another embodiment in an unfolded configuration;

FIG. 6B is a side view of the floor mat of FIG. 6A in the unfolded configuration;

FIG. 6C is a side view of the floor mat of FIG. 6A in a folded configuration;

FIG. 7A is a top view of a floor mat consistent with another embodiment in an unfolded configuration;

FIG. 7B is a side view of the floor mat of FIG. 7A in a partially folded configuration;

FIG. 7C is another side view of the floor mat of FIG. 7B in a partially folded configuration;

FIG. 7D is a side view of the floor mat of FIG. 7A in a completely folded configuration;

FIG. 7E is another side view of the flood mat of FIG. 7A in the completely folded configuration;

FIG. 7F is another perspective view of the floor mat of FIG. 7A in a partially folded configuration;

FIG. 8A is a partial top view of two adjacent panels and a fold line between the two panels in an unfolded configuration consistent with an embodiment;

FIG. 8B is a side view of the two adjacent panels and the fold line of FIG. 8A in the unfolded configuration;

FIG. 8C is a side view of the two adjacent panels and the fold line of FIG. 8A in a folded configuration;

FIG. 9A is a partial top view of two adjacent panels and a plurality of fold lines between the two panels in an unfolded configuration consistent with the floor mat of FIG. 7A;

FIG. 9B is a side view of the two adjacent panels and the plurality of fold lines of FIG. 9A in the unfolded configuration;

FIG. 9C is a side view of the two adjacent panels and the plurality of fold lines of FIG. 9A in a folded configuration;

FIG. 10A is a perspective view of a floor mat consistent with another embodiment;

FIG. 10B is a side view of the floor mat of FIG. 10A;

FIG. 11 is a top view of a floor mat with yet another embodiment; and

FIG. 12 is a flow diagram of a method according to an embodiment.

### DETAILED DESCRIPTION

The present invention or inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

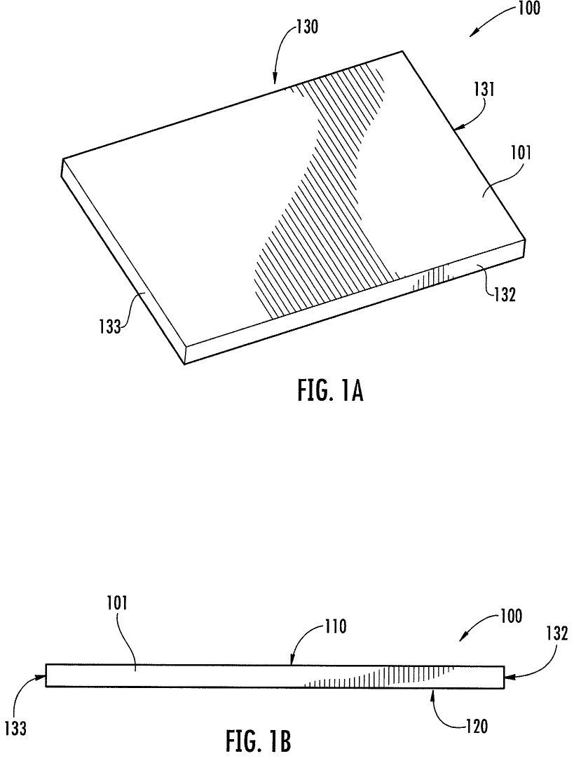

FIGS. 1A-1B illustrate a floor mat 100. The floor mat 100 includes a body 101 having a top surface 110 and a bottom surface 120. The body 101 may further include one or more side surfaces 130, 131, 132, 133 extending along the perimeter of the floor mat and between the top and bottom surfaces 110, 120. The distance between the top surface 110 and the bottom surface 120 defines a thickness of the body 101. In the embodiment illustrated in FIGS. 1A-1B, the top surface 110 and the bottom surface 120 are generally in a parallel relationship such that the body 101 has a uniform thickness throughout.

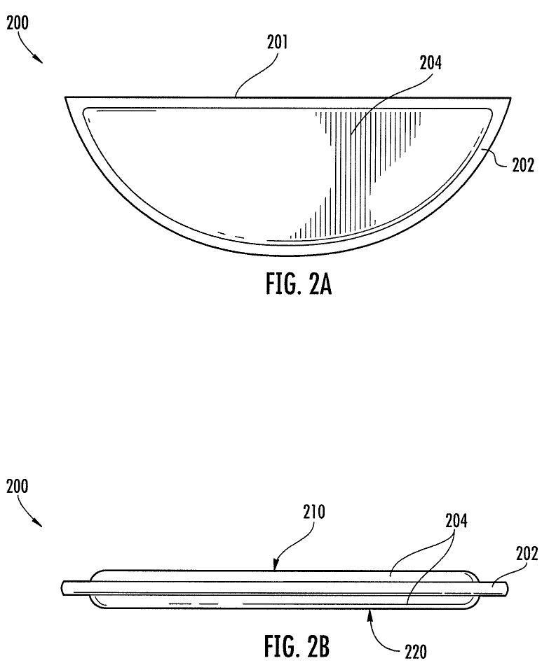

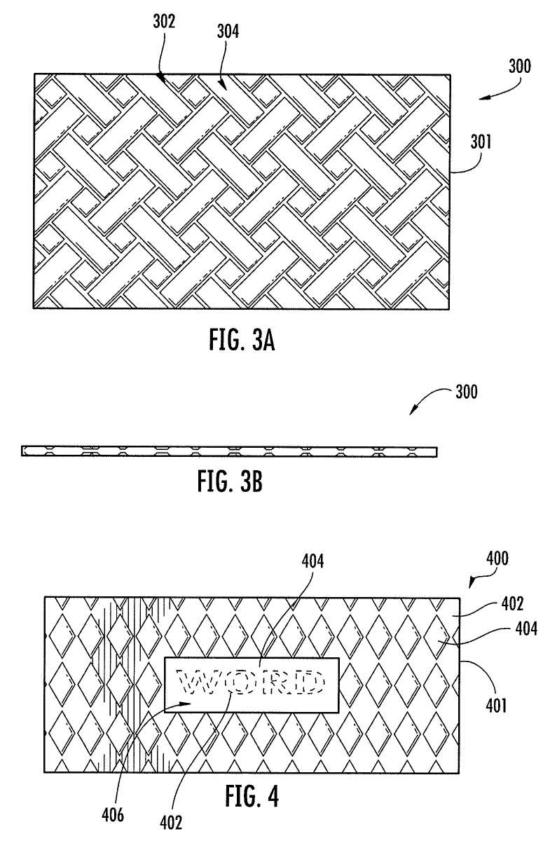

In other embodiments, the thickness of the body may vary. For example, in the embodiment illustrated in FIGS. 2A-2B, the top and bottom surfaces 210, 220 of the body are closer together around the perimeter 202 of the body 201 compared to a central region 204 of the body 201 as shown. As shown the overall shape of the mat 200 may be a half-moon shape. The central region 204 may be concentric with the rest of the mat and also have a half-moon shape and the perimeter 202 defined by the relative thinner region may continuous extend around the central region 204. As another example, in the embodiment illustrated in FIGS. 3A-3B, the body 301 of the floor mat 300 may define a plurality of relatively thinner 302 and thicker regions 304 to form a pattern. More specifically, according to the embodiment illustrated in FIGS. 3A-3B, the thinner 302 and thicker regions 304 of the body form a pattern of bricks or blocks extending in a diagonal manner across the body 301 of the floor mat 300. FIG. 4 illustrates yet another example of a pattern defined by a plurality of relatively thinner 402 and thicker regions 404 in the body 401 of the floor mat 400. The pattern of FIG. 4 includes rows and columns of objects shaped like a diamond and a central region 406 with a word formed using the thinner 402 and thicker regions 404. The terms “relatively thinner”, “thinner”, “relatively thicker”, and “thicker” as used herein are in reference to the thickness of a portion or region of the body of the mat relative to other portions or regions of the mat. Relative thinner and thicker regions may be alternated to form a similar but inverted pattern.

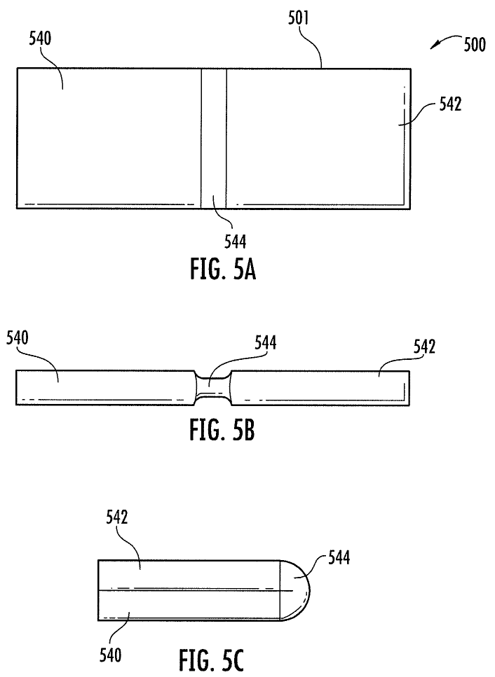

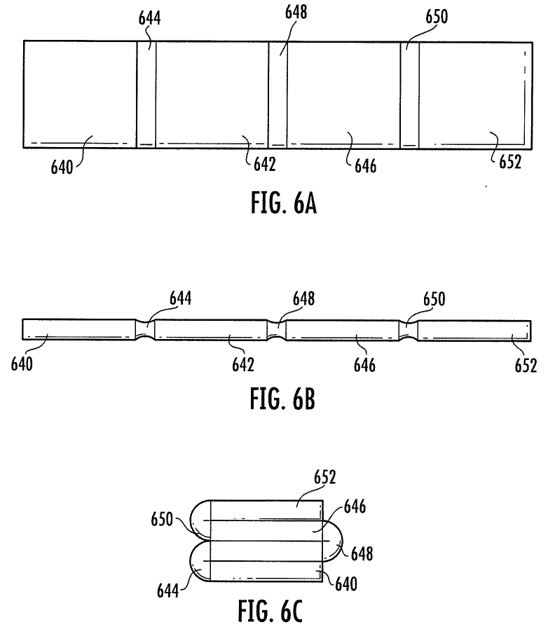

A body of a floor mat may have one or more thinner regions that form one or more fold lines of the body of the floor mat. For example and as illustrated in FIGS. 5A-5C, the body 501 of the floor mat 500 may include a first panel 540, a second panel 542, and a fold line 544 extending between the first and second panels 540, 542. The fold line 544 is formed by a thinner region relative to the first and second panels which facilitates the bending of folding of the floor mat 500 as shown in FIG. 5C. FIGS. 6A-6C illustrate an exemplary embodiment of a floor mat 600 having a plurality of fold lines 644, 648, 650 and a plurality of panels 640, 642, 646, 652. More specifically, FIGS. 6A and 6B illustrate the floor mat 600 in a first configuration in which the panels 640, 642, 646, 652 are unfolded and FIG. 6C illustrates the floor mat 600 in a second configuration in which the panels 640, 642, 646, 652 are folded or stacked on top of one or another.

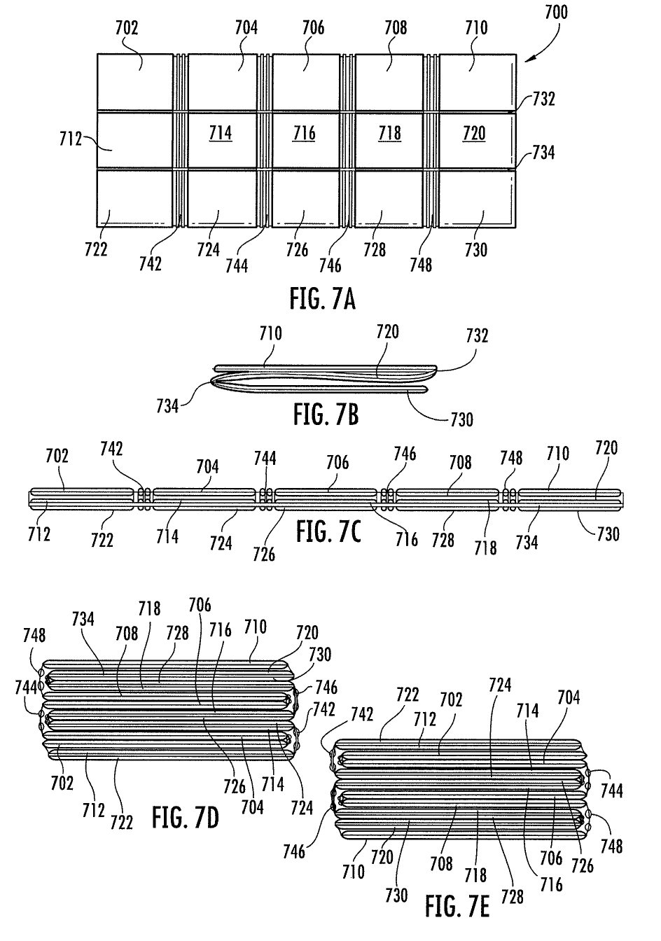

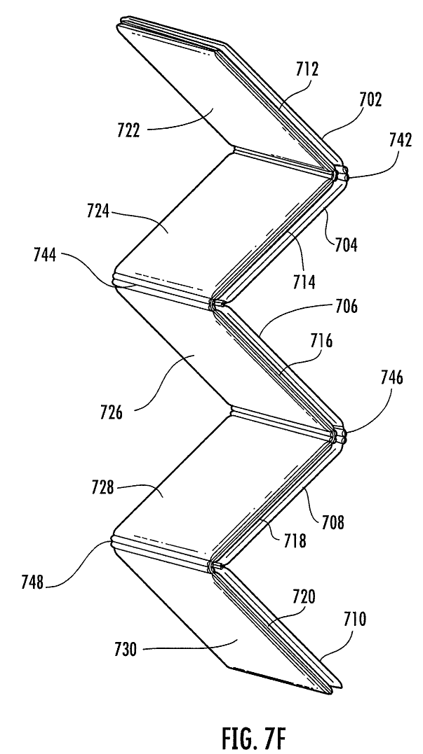

FIGS. 7A-7F illustrate another exemplary embodiment of a floor mat 700 having a plurality of fold lines. In this embodiment, the body of the floor mat has a first plurality of fold lines 732, 734 extending along a first direction of the mat, e.g., lengthwise, and a second plurality of fold lines 742, 744, 746, 748 extending along a second direction of the mat, e.g., widthwise. The fold lines define a plurality of panels 702, 704, 706, 708, 710, 712, 714, 716, 718, 720, 722, 724, 726, 728, 730 of the body of the floor mat extending in rows and columns. FIG. 7A illustrates the body 701 of the floor mat 700 in a first configuration in which the panels 702, 704, 706, 708, 710, 712, 714, 716, 718, 720, 722, 724, 726, 728, 730 of the body are unfolded. FIGS. 7B and 7C illustrates the body 701 of the floor mat 700 in a second configuration, i.e., a partially folded configuration, in which the panels 702, 704, 706, 708, 710, 712, 714, 716, 718, 720, 722, 724, 726, 728, 730 are folded along the first plurality of fold lines 732, 734 that extend lengthwise (or between adjacent columns of panels) and are unfolded along the second plurality of fold lines 742, 744, 746, 748 that extend widthwise (or between adjacent rows of panels). FIGS. 7D-7E illustrate the body 701 of the floor mat 700 in a third configuration in which the panels 702, 704, 706, 708, 710, 712, 714, 716, 718, 720, 722, 724, 726, 728, 730 are folded along the first plurality of fold lines 732, 734 and along the second plurality of fold lines 742, 744, 746, 748 such that all the panels are stacked on top of one another.

It is understood that the illustrated embodiment of FIGS. 7A-7F is an exemplary embodiment. In other embodiments, the number of panels including the number of rows and columns may vary. The plurality of fold lines allow for the floor mat to be folded up into a folded configuration such that the overall footprint of the floor mat or, more specifically, the body of the floor mat is reduced, e.g., equal to a single panel. The folded configuration allows for the floor mat to be stored or transported more easily. In the unfolded configuration, the footprint of the floor mat is increased, e.g., equal to rows and columns of panels, allowing the floor mat to cover more of the floor.

In the illustrated embodiment of FIGS. 7A-7F, the panels are folded lengthwise first and then widthwise. By folding the panels lengthwise, the overall thickness of the floor mat is increased. For example, as in the illustrated embodiment of FIGS. 7A-7F, folding the floor mat twice along its length increases the thickness by a factor of three (i.e., there are three stacked columns of panels). Due to the increase of the overall thickness, the fold lines extending widthwise may be wider than the fold lines extending lengthwise to accommodate for the increase thickness of the folded floor mat. In general, to accommodate a fold of the body of the floor mat, the width of a fold line may increase as the material thickness increases. The increased width of the fold line provides a greater folding radius separation between the two panels.

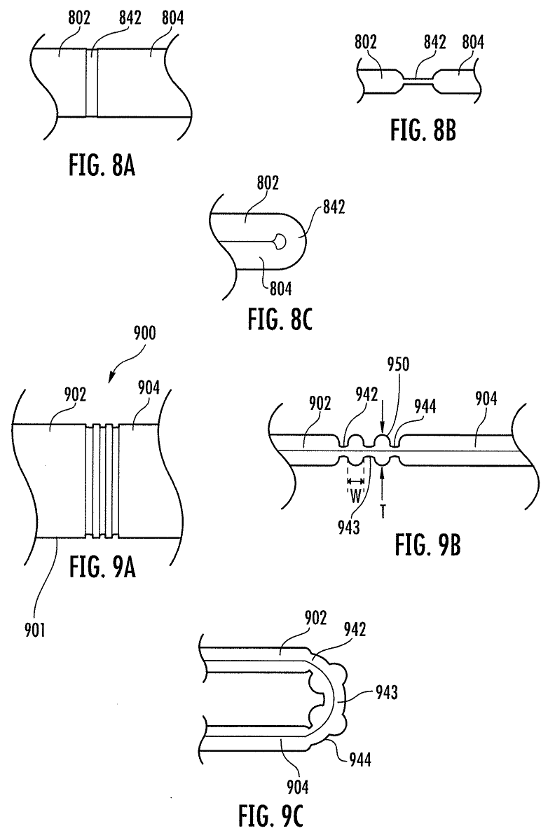

Although increasing the width of the fold lines may help to facilitate the folding of the mat despite of the already stacked panels, the fold lines are thinner than the panels and thus provide less cushion or support than the panels. Therefore a relative wide fold lines may be less than optimal. Rather than provide a single wide fold line 842 between adjacent panels 802, 804 as shown in FIGS. 8A-8c, the body 901 of the floor mat 900 may include a plurality of fold lines 942, 943, 944 between adjacent panels 902, 904, e.g., as shown in FIGS. 9A-9C. The plurality of fold lines 942, 943, 944 between the adjacent panels 902, 904 provide a greater folding radius similar to the folding radius of the single wider folding line of FIGS. 8A-8c. The fold lines 942, 943, 943 are separated by a strip or bead of material 950 with a thickness T similar or substantially equal to the thickness of the panels 902, 904. The strip of material has a relative small width W compared to the panels. The relative small width of the strip of material facilitates the bending of the three fold lines and thus the folding of the panels. However, the thickness T of the strip of material allows for the strip of material to provide cushioning similar to the cushioning of the panels. In other words, the strip of material has little to no impact of the fold lines ability to bend and support the folding of the panels (i.e., little or no impact of the folding radius) even in situations such as the embodiment of FIGS. 7A-7D in which the overall thickness of the floor mat has been increased due to a partial stacking of the panels and helps to break up and providing cushioning to what would otherwise be a relative single wide fold line such as in FIGS. 8A-8c.

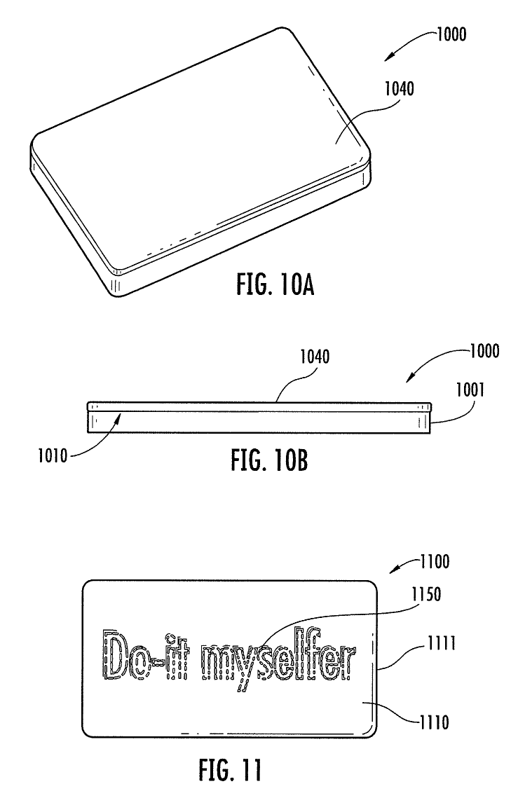

Typically, the floor mat is placed on a floor such as a tiled floor or a carpeted floor, with the bottom surface facing down and the top surface facing up. As such, in many embodiments, the top surface of the body is the only surface intended to be visible during use and be the surface in which people, pets, and other things will either walk on or rest on, while bottom surface is intended to be faced down against a surface of the floor. In many embodiments, the top surface of the floor mat may have a particular texture or other decorative aspect to improve the aesthetic appearance of the floor. For example, in addition to the patterns discussed above (e.g., the block and diamond shaped objects) the top surface may be textured such that it has a rough finish. In other embodiments and as shown in FIGS. 10A-10B, a fabric layer 1040 may be attached (e.g., glued or melted) to the top surface 1010 of the body 1001 of the floor mat 1000, such as to improve the aesthetic appearance of the floor mat 1000. As another example and as illustrated in FIG. 11, the floor mat 1100 may include an embroidered pattern 1150 on the top surface 1110 of the body 1111. The embroidered pattern may include one or more yarns itched or sewed into the top surface to spell out a particular word or words or other graphic or pattern.

Because the bottom surface of the body is not intended to be visible during use, in some embodiments, the bottom surface may not include the same decorative aspects of the top surface. In some embodiments, rather than to include decorative aspects, the bottom surface may include features to help the bottom surface to stick to the surface of the floor or otherwise minimize the likelihood of the floor mat slipping relative to the floor. For example, a non-slip coating may be applied to the bottom surface of the body or the bottom surface of the body may include one or more ribs configured to increase the friction between the floor and the bottom surface.

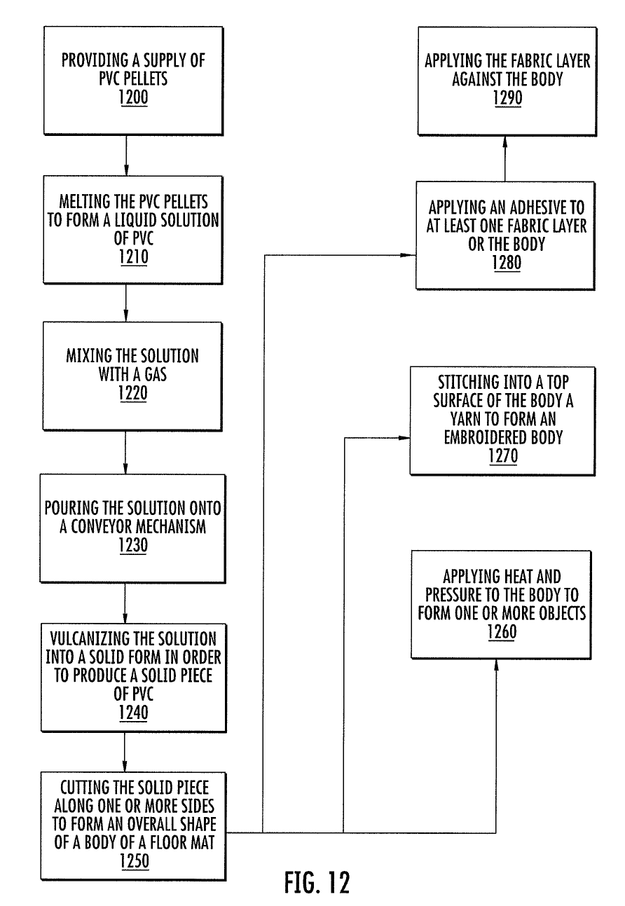

The floor mats according to the embodiments discussed above may be made primarily from polyvinyl chloride or PVC or other cushioning material. More specifically, according to the illustrated embodiment of FIG. 12, a floor mat may be made through a liquid process or method. The method may include providing a supply of PVC pellets 1200. The pellets may be free of phthalates or other substances in order to comply with governmental laws and regulations. The PVC pellets may also include a blowing agent that may be activated during the method of making the floor mat to provide a foam PVC floor mat or, more specifically, a foam PVC body of a floor mat. The method may further include melting the PVC pellets to form a liquid solution of PVC 1210; mixing the solution with a gas 1220, e.g., air; and pouring the solution onto a conveyor mechanism 1230, e.g., a conveyor belt or, more specifically, a nylon belt. The conveyor mechanism may be configured to transport the liquid solution to an oven configured to vulcanize the solution into a solid form in order to produce a solid piece of PVC 1240. The method may further include cutting the solid piece of PVC along one or more sides to form an overall shape of a body of a floor mat 1250. For example, the conveyor mechanism may be further configured to transport the solid piece of PVC to a cutting press. Although the bodies of the floor mats of many of the illustrated embodiments have generally a rectangular shape, the overall shape of a body of a floor mat may vary. For example, as illustrated in FIG. 2A, the overall shape may be a half-moon shape. Additional examples of overall shapes for the body of the floor mat include, but not limited to, circular, oval, triangular, hexagon, pentagon, octagon, or unconventional shapes, such as a shape of a letter or number or object. The portions of the PVC cut away to form the body of the floor mat may be recycled to be used in part of the making of another floor mat.

In addition to the above operations, the method may further include an embossing operation. For example, the conveyor mechanism may be configured to transport the body of the floor mat to a press station. At the press station, heat and pressure may be applied to the body of floor mat to form one or more objects in the body of the floor mat 1260. In some embodiments, the body of the floor mat may still be sufficiently heated from the vulcanization operation that the application of heat again at the embossing operation is not necessary. The objects may include fold lines, a thinner perimeter of the body of the floor mat, and the patterns (e.g., the block, diamond, and word pattern) discussed above regarding the illustrated embodiments. In general, the application of the heat and pressure form the relatively thinner portions or areas of the body of the floor mat. The selective application of the heat and pressure on the body of the floor mat may be used to form one or more the relatively thinner portions of the body of floor mat throughout the floor mat to form the objects.

In yet another embodiment of the method, the method may include an embroidery operation. More specifically, yarn or other textile may be stitched into the top surface of the body according to a particular design in order to form an embroidered pattern such as one or more words 1270. As with the other operations, the conveyor mechanism may be configured to deliver the floor mat to a particular work station configured to perform the operation. For example, the work station may include a sewing mechanism configured to stitch the yarn into the body of the floor mat. The sewing mechanism may be controlled by a computer control in order to control the designs stitched into the floor mat or subsequent floor mats. For example, the design stitched into the floor mats may vary according to orders received by or demand from customers.

As illustrated in FIGS. 10A-10B, a floor mat may include a fabric layer attached to the top surface of the body of the floor mat. In such embodiments, the method of manufacturing may include applying an adhesive to at least one of the fabric layer and the top surface of the body of the floor mat 1280 and applying the fabric layer against the top surface of the body such that the adhesive attaches the fabric layer to the top surface of the body of the floor mat 1290. According to this embodiment, the fabric layer is held to the body of floor mat only by the adhesive and no sewing or other operation is necessary to hold the two together. In some embodiments, the fabric layer is adhered to the uncut piece of PVC, i.e., before the cutting operation that forms the overall shape of the body of the floor mat. With the fabric layer already attached, the fabric layer will be cut along with the rest of the floor mat which helps to ensure that the fabric layer has the same shape as the top surface of the body of the floor mat. In other embodiment, the fabric layer may be pre-cut to match the shape of the top surface of the body and thus may be applied after the cutting operation. In other embodiments, the fabric layer may be pressed against the top surface of the body of the floor mat while the body is still heat in order to form a seal between the fabric layer and the body such that non adhesive is necessary.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A floor mat comprising:
a body of a foam polyvinyl chloride material having at least a top surface and a bottom surface and defining a thickness, wherein the thickness varies to form at least one thinner region of the body and at least one thicker region of the body.

2. The floor mat according to claim 1, wherein the body includes a plurality of panels formed by a plurality of relative thicker regions of the body and a plurality of fold lines formed by a plurality of relative thinner regions of the body, at least one fold line extends between each adjacent panels such that that the plurality of panels are foldable relative to each other.

3. The floor mat according to claim 2, wherein the plurality of panels include a plurality of rows of panels and a plurality of columns of panels, and the plurality of fold lines include at least one fold line extending in a first direction between each adjacent columns of panels and include at least one fold line extending in a second direction between each adjacent rows of panels.

4. The floor mat according to claim 3, wherein the plurality of fold lines include a plurality of fold lines extending in the second direction between each adjacent rows of panels.

5. The floor mat according to claim 4, wherein the plurality of fold lines include three fold lines extending in the second direction between each adjacent rows of panels and wherein the body further include a bead of the foam PVC material having a thickness substantially equal to the thickness of a panel between each of the three fold lines.

6. The floor mat according to claim 1, wherein the body includes a plurality of thinner and thicker regions that form a pattern of bricks extending across the body.

7. The floor mat according to claim 1, wherein the body includes a plurality of thinner and thicker regions that form a pattern that includes a plurality of rows and columns of an object.

8. The floor mat according to claim 7, wherein the pattern further includes a central region forming one or more words.

9. A floor mat comprising:
a body of a foam polyvinyl chloride material having at least a top surface and a bottom surface and defining a thickness; and
a fabric layer attached to the top surface by an adhesive.

10. A floor mat comprising:
a body of a foam polyvinyl chloride material having at least a top surface and a bottom surface and defining a thickness; and
one or more textiles stitched into the top surface according to a particular pattern.

11. A method of manufacturing a floor mat comprising:
providing a supply of polyvinyl chloride pellets;
melting the polyvinyl chloride pellets to form a liquid solution of polyvinyl chloride;
vulcanizing the liquid solution into a sold form in order to produce a body of the floor mat;
cutting the body according to a desired overall shape of the floor mat; and
embossing the body to form one or more thicker and thinner regions of the body.

12. The method according to claim 11 further comprising activating a blowing agent of the polyvinyl chloride pellets such that the body is of a foam polyvinyl chloride material.

13. The method according to claim 11, wherein the embossing of the body includes forming a plurality of panels and fold lines with the one or more thicker and thinner regions of the body such that the panels are foldable relative to one another.

14. The method according to claim 13, wherein the embossing of the body includes forming a plurality of fold lines between at least two adjacent panels.

15. The method according to claim 11, wherein the embossing of the body includes forming a pattern of bricks extending across the body with the one or more thicker and thinner regions.

16. The method according to claim 11, wherein the embossing of the body includes forming a pattern that includes a plurality of rows and columns of an object with the one or more thicker and thinner regions.

17. The method according to claim 16, wherein the pattern further includes a central region forming one or more words.

18. A method of manufacturing a floor mat comprising:
providing a supply of polyvinyl chloride pellets;
melting the polyvinyl chloride pellets to form a liquid solution of polyvinyl chloride;
vulcanizing the liquid solution into a sold form in order to produce a body of the floor mat;
cutting the body according to a desired overall shape of the floor mat; and
embroidering a particular design into the body.

19. A method of manufacturing a floor mat comprising:
providing a supply of polyvinyl chloride pellets;
melting the polyvinyl chloride pellets to form a liquid solution of polyvinyl chloride;
vulcanizing the liquid solution into a sold form in order to produce a body of the floor mat;
cutting the body according to a desired overall shape of the floor mat; and
attaching a fabric layer to a top surface of the body.

20. The method according to claim 19, wherein the cutting of the body is performed prior to the operation of adhering the fabric layer to the top surface of the body.
